(19) United States
(12) Patent Application Publication
(10) Pub. No.: US 2002/0001708 A1
(43) Pub. Date: Jan. 3, 2002

(54) Coating compositions having improved hiding powder

(76) Inventors: Kenneth A. Flaherty, Beverly Hills, MI (US); James G. King, Birmingham, MI (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/915,816

(22) Filed: Jul. 26, 2001

Related U.S. Application Data
(63) Continuation of application No. 09/650,186, filed on Aug. 29, 2000.
Application No. 09/650,186 is a continuation of application No. 09/252,276, filed on Feb. 18, 1999, now abandoned.
(60) Provisional application No. 60/104,884, filed on Oct. 20, 1998.

(51) Int. Cl. B32B 5/16; B32B 27/30; C08K 3/08; C08K 3/22

(52) U.S. Cl. 428/328; 428/329; 524/441; 524/413; 524/431; 524/437

(57) ABSTRACT

A coating composition containing the following:

(a) a liquid carrier medium:

(b) pigment;

(c) a film forming binder of a polymer having reactive groups and a crosslinking agent which on curing of the coating composition will react with the reactive groups of the polymer to form a film and

(d) 0.1-3.0% by weight, based on the weight of the binder, of iron oxide coated aluminum flake to provide the coating composition when applied to a substrate and cured with improved chip resistance and improved hiding power.

### TECHNICAL FIELD

This invention relates to coating compositions that have improved hiding power and in particular to coating compositions that contain a small amount of a colored aluminum flake that significantly improves the hiding power of the compositions without introducing any metallic luster.

### BACKGROUND OF THE INVENTION

The use of aluminum flake in coating compositions to enhance appearance such as providing metallic luster is well known as shown in U.S. Pat. No.4,484,951 issued Nov. 27, 1984 to Uchimura et al and U.S. Pat. No.4,937,274 issued Jun. 26, 1990 to Arima et al. Coated aluminum flakes that provide chromatic color effects are known as shown in U.S. Pat. No. 5,091,010 issued Feb. 25, 1992 to Souma et al and Canadian Patent No. 871,035 issued May 18, 1971. The art is mainly directed to enhancing the appearance of finishes by the incorporation of aluminum flake or coated aluminum flake to provide metallic luster and sparkle. The concept of using aluminum flake to improve only the physical properties of a coating composition such as hiding power of the composition or adhesion of the coating to a substrate which can be determined by a chip resistance test without imparting metallic luster to the resulting finish is not known.

Hiding power is the ability of a coating composition to hide or obscure a surface over which it has been applied uniformly. The addition of pigments in large amounts increases the hiding power of a coating composition. However, many colored pigments such as red pigments and yellow pigments are complex organic compounds having a high molecular weight and these pigments increase the viscosity of a coating composition and additional solvents are needed to reduce the coating composition to a spray viscosity. Further, these pigments are very expensive. For these reasons, it would be desirable to decrease the amount of such pigments while maintaining the same level of hiding power of the composition. Any pigments that are substituted for these expensive colored pigments must not change the color or appearance of the coating composition, must be less expensive and maintain or preferably improve physical properties such as chip resistance and hiding power of the coating composition.

### SUMMARY OF THE INVENTION

A coating composition containing the following:

(a) a liquid carrier medium:

(b) pigment;

(c) a film forming binder of a polymer having reactive groups and a crosslinking agent which on curing of the coating composition will react with the reactive groups of the polymer to form a film and

(d) 0.1-3.0% by weight, based on the weight of the binder, of colored aluminum flake to provide the coating composition when applied to a substrate and cured with improved chip resistance and improved hiding power.

### DETAILED DESCRIPTION OF THE INVENTION

The coating composition utilizes a relatively small amount of a colored aluminum flake (0.1-3.0% based on the weight of the binder) to enhance the hiding power of the coating composition and also improve physical properties such as chip resistance. An economic side benefit of the use of the colored aluminum flake is that the amount of expensive color pigments such as red and yellow pigments can be significantly reduced while the hiding power either remains the same, or as in most cases, is improved even with the reduction of these pigments. The result is that a coating composition made with these colored aluminum flakes has improved physical properties and lower volatile organic content when reduced to a spray viscosity with solvents and has a lower cost. The level of colored aluminum flake in the coating composition is below the minimum level required to provide metallic luster or sparkle to the resulting finish.

The coating composition of this invention contains 10-70% by weight of film forming polymeric components which include the film forming polymer binder, a crosslinking agent and polymer dispersants which can crosslink with the crosslinking agent on curing of the composition and a corresponding amount of 30-90% by weight of a liquid carrier which usually is an organic solvent or a mixture of organic solvents and nonsolvents for the polymeric components. An aqueous carrier which is primarily water but can contain organic solvents can also be used.

The colored aluminum flake is used in the coating composition in amounts of 0.1-3.0% by weight, and preferably 0.15-1.50% by weight, based on the weight of the binder of the coating composition, and has a particle diameter of 1 to 50 microns. Particularly suitable colored aluminum flakes are red, orange, or yellow flakes having a mass tone color position of CIE LCH Hue angle values between 0-90 degrees.

CIE LCH is an international standard industrial color difference notation system. The letters “CIE” are an acronym for the French name of the international lighting communication. “LCH” stands for lightness, hue and chroma used for standard color notation.

One type of colored aluminum flake is manufactured via a fluidized bed vapor deposition process described in Ostertag et al U.S. Pat. No. 4,328,042, issued May 4, 1982. In this process, aluminum flakes in a fluidized bed are coated via a vapor deposition process with an iron oxide coating by a controlled decomposition of iron pentacarbonyl and oxygen. A particularly useful flake is “Paliocrom” Gold L2020 manufactured by BASF and has a mass tone color position of CIE Lab [0,45]; L=53.83, a=14.61, b=47.40, hA=72.87, C=49.60 and a particle size distribution of D₁₀-10 microns, D₅₀-16 microns and D₉₀-27 microns.

Other colored aluminum flakes are manufactured by adhering small amounts of conventional colored pigments to the surface of the aluminum flake using various known crosslinked polymers. Examples of such flakes are “Deep Color Pigments” from Showa Aluminum KK.

The coating composition contains a film forming binder typically an acrylic polymer or a polyester or a mixture of the two and optionally a microgel and a curing agent such as a polyisocyanate or an alkylated melamine. These provide excellent coating properties desirable for automotive finishes.

Typically useful acrylic polymers used in the coating composition are prepared by conventional polymerization techniques well known in the art wherein monomers, catalyst and solvents are charged into a polymerization vessel at various rates and heated and polymerization takes place to obtain the polymer desired. Typically, these polymers have a number average molecular weight of 2,000-30,000.

All molecular weights referred herein are determined by GPC (gel permeation chromatography) using a polystyrene standard.

Typical monomers used to form these acrylic polymers are alkyl (meth)acrylates having 1-12 carbon atoms in the alkyl group, hydroxy alkyl (meth)acrylates having 1-4 carbon atoms in the alkyl group and ethylenically unsaturated carboxylic acids.

The term (meth)acrylate refers to both the acrylate and methacrylate esters.

Typically useful alkyl (meth)acrylates having 1-12 carbons in the alkyl group that can be used in forming the acrylic polymer are methyl acrylate, ethyl acrylate, propyl acrylate, isopropyl acrylate, butyl acrylate, pentyl acrylate, hexyl acrylate, 2-ethyl hexyl acrylate, nonyl acrylate, lauryl acrylate, methyl methacrylate, ethyl methacrylate, propyl methacrylate, isopropyl methacrylate, butyl methacrylate, pentyl methacrylate, hexyl methacrylate, 2-ethyl hexyl methacrylate, nonyl methacrylate and lauryl methacrylate and any mixtures thereof. Other monomers that can be used with the alkyl (meth)acrylate monomers are isobornyl methacrylate and benzyl methacrylate. Styrene may be used for a portion of the alkyl (meth)acrylate monomers.

Typically useful hydroxy alkyl (meth)acrylates having 1-4 carbon atoms in the alkyl group that can be used are hydroxyethyl methacrylate, hydroxyethyl acrylate, hydroxypropyl methacrylate, hydroxypropyl acrylate, hydroxybutyl methacrylate and hydroxybutyl acrylate.

Typical ethylenically unsaturated acids, that can be used are acrylic acid and methacrylic acid.

Typical polyesters that can be used are the esterification product of a polycarboxylic acid and a polyol. Typical polycarboxylic acids and anhydrides of some of these acids that can be used are phthalic acid, phthalic anhydride, isophthalic acid, terephthalic acid, maleic acid, adipic acid, 1,12 dodecandioc acid and the like. Typical polyols that can be used are ethylene glycol, butane diol, hexane diol, trimethylol propane, trimethylol ethane, and the like

Microgel polymers also can be used which typically are nonaqueous dispersions of acrylic polymers.

The coating composition contains pigments that are conventionally used in coating compositions. These pigments are dispersed with a dispersing resin or polymer. Typically, AB block copolymers and microgel polymers are used as a dispersing resins to disperse a wide variety of these commonly used pigments.

Typical pigments that are used are carbon black, metallic oxides such as iron oxides of various colors, bismuth vanadate, carbon black, filler pigments such as silicates and a wide variety of organic colored pigments such as quinacridones, isoindolinones, benzimidazolones, copper phthalocyanines and perylenes.

Preferably, red, orange and yellow organic pigments and mixtures thereof are pigments that are used in the coating composition since the colored aluminum flake provides improvement in hiding, chip improvement and the reduction in the amount of these pigments (which reduces cost) in the composition. Such pigments are, for example, organic red pigments such as “Irgazin” DPP Red BO, “Monastral” Red RT-859-D, “Monastral” Magenta RT-355-D, and organic yellow pigments such as Sicopal Yellow L-1100, “Hostaperm” Yellow H3G, “Irgazin” Yellow 3RLTN.

To form a pigment dispersion used to formulate the coating composition of this invention, the dispersing polymer and the pigment to be dispersed are added to a suitable mixing vessel such as an attritor, sand mill, ball mill, two roll mill and the like and then mixed for about 5-150 minutes to form a dispersion. Aluminum flake containing dispersions are mixed under less vigorous conditions that prevent break down of the flake.

The coating composition of this invention contains crosslinking agents such as a melamine crosslinking agents typically fully or partially alkylated melamine crosslinking agents which may be monomeric or polymeric such as methylated melamine formaldehyde, methylated/butylated melamine formaldehyde and the like. A polyisocyanate crosslinking agent or a blocked polyisocyanate crosslinking agent can also be used. The polyisocyanate provides a composition that will cure at ambient temperatures.

To form a coating composition which will crosslink under elevated baking temperatures of 60-180° C. for 5-60 minutes, 10 to 50%, preferably 15 to 30% by weight, based on the weight of the binder, of an alkylated melamine formaldehyde crosslinking agent having 1-4 carbon atoms in the alkylated group is preferred.

Coating compositions containing a melamine crosslinking agent can contain 0.1 to 1.0% by weight, based on the weight of a binder, of a strong acid catalyst or a salt thereof to lower curing temperatures and time. Aromatic sulfonic acids such as dodecyl benzene sulfonic acid, para toluene sulfonic acid or the ammonium salts thereof are preferred catalysts. Other catalysts that can be used are phosphoric acid and its amine or ammonium salts.

Other film forming polymers can also be used in these coating compositions such as acrylourethanes, polyesters and polyester urethanes, polyethers and polyether urethanes that are compatible.

In addition, coating composition of the present invention may contain a variety of other optional ingredients, including fillers, plasticizers, antioxidants, surfactants and flow control agents.

To improve weatherability of a finish of the novel coating compositions, an ultraviolet light stabilizer or a combination of ultraviolet light stabilizers can be added in the amount of 0.1-5.0% by weight, based on the weight of the binder. The stabilizer may be added for example to the pigment dispersion or may be added directly to the coating composition. Such stabilizers include ultraviolet light absorbers, screeners, quenchers, and specific hindered amine light stabilizers. Also, an antioxidant can be added, in the amount of 0.1-5.0% by weight, based on the weight of the binder.

Typical ultraviolet light stabilizers that are useful include benzophenones, triazoles, triazines, benzoates, hindered amines and mixtures thereof. Specific examples of ultraviolet stabilizers are disclosed in U.S. Pat. No. 4,591,533, the entire disclosure of which is incorporated herein by reference.

The coating composition may also include conventional formulation additives such as flow control agents, for example, “Resiflow” S (polybutylacrylate), BYK 320 and 325 (high molecular weight polyacrylates); rheology control agents, such as fumed silica and thickeners such as the Acrylsol® copolymers from Rohm & Haas.

The coating compositions of the present invention may be utilized as a mono coat or in a pigmented color coat or base coat over which a clear coat is applied to provide a color coat/clearcoat finish.

Coating compositions of this invention have excellent adhesion to a variety of metallic or non-metallic substrates, such as previously painted substrates, primed substrates cold rolled steel, phosphatized steel, and steel coated with conventional primers by electrodeposition. These coating compositions also can be used to coat plastic substrates such as polyester reinforced fiberglass, reaction injection-molded urethanes and partially crystalline polyamides. In particular, the base coat or color coat compositions of this invention, provide improved cohesion within the base coat by allowing reduction of the overall pigment content. This improved cohesion results in improved chip resistance of the resulting finish which is very important property for automobile and truck finishes.

Coating compositions of this invention can be applied by conventional techniques such as spraying, electrostatic spraying, dipping, brushing, flowcoating and the like. The preferred techniques are spraying and electrostatic spraying. In OEM applications, the composition is typically baked at 100-150° C. for 15-30 minutes to form a coating 0.1-3.0 mils (2.54-76.2 microns) thick. The present invention also is applicable to non-baking refinish systems.

The following Examples illustrate the invention. All parts, ratios and percentages are on a weight basis unless otherwise indicated. All molecular weights disclosed herein are determined by GPC (gel permeation chromatography) using a polystyrene standard.

### EXAMPLE 1

The following constituents were blended together to form Coating Composition A (the invention):

| | Parts by |
|---|---|
| | Weight |
| Non aqueous polymer dispersion (50% solids of an acrylic | 109.49 |
| polymer dispersed in organic solvents) | |
| Melamine formaldehyde resin (ailcylated melamine | 127.99 |
| formaldehyde resin) | |
| Xylene | 53.48 |
| U.V inhibitor solution [25% solids in a mixture of ethyl | 14.60 |
| benzene and xylene of 2(2′-hydroxy-3,5′- | |
| diteramyiphenyl) benzotriazole] | |
| Acid catalyst solution (33.6% solids of dodecyl benzene | 8.69 |
| sulfonic acid neutralized with amino methyl propanol in a | |
| mixture of methanol and isopropanol) | |
| Catalyst solution (7% solids of dibutyl tin oxide in a | 14.45 |
| mixture of acetic anhydride, ethylbenzene and xylene) | |
| Hindered amine light stabilizer solution | 7.30 |
| Branched polyester resin solution (81% solids in mixture | 60.73 |
| of organic solvents of a polyester extended with an | |
| organic diisocyanate) | |
| Red pigment dispersion (22% solids of diketo- | 127.06 |
| pyrrolopyrrol red pigment dispersed with A-B dispersant | |
| resins in organic solvent blend) | |
| Quinacridone red pigment dispersion (23.2% solids | 215.69 |
| quinacridone red pigment dispersed with a dispersant resin | |
| in a mixture of organic solvents) | |
| Quinacridone pigment dispersion (19.0% solids of | 31.84 |
| quinacridone pigment dispersed with A-B dispersant | |
| resins in a mixture of organic solvents) | |
| Benzimidazolone orange pigment dispersion (20% solids | 33.74 |
| of benzimidazolone orange pigment dispersed with a | |
| polymeric dispersant in a mixture of organic solvents) | |
| Iron oxide coated aluminum flake dispersion (35.8% | 1.25 |
| solids iron oxide coated aluminum flake dispersed with | |
| non-aqueous polymer dispersion described above in a | |
| mixture of organic solvents) | |
| Methanol | 20.71 |
| Total | 826.66 |

The resulting Coating Composition A had a solids content of 55%, a pigment to binder weight ratio of 25/100 and a viscosity of 44 seconds measured at 25C using a No. 2 Fisher Cup.

The following constituents were blended together to form Coating Composition B (prior art):

| | Parts by Weight |
|---|---|
| Non-aqueous polymer dispersion (described above) | 107.17 |
| Melamine formaldehyde resin (described above) | 125.28 |
| Xylene | 24.19 |
| U.V inhibitor solution (described above) | 14.28 |
| Acid catalyst solution (described above) | 8.51 |
| Catalyst solution (described above) | 14.15 |
| Hindered amine light stabilizer (described above) | 7.15 |
| Branched polyester resin solution (described above) | 29.06 |
| Red pigment dispersion (described above) | 149.25 |
| Quinacridone red pigment dispersion (described above) | 253.28 |
| Quinacridone pigment dispersion (described above) | 37.39 |
| Benzimidazolone orange pigment dispersion (described | 42.68 |
| above) | |
| Methanol | 19.63 |
| Total | 832.02 |

The resulting Coating Composition B had a solids content of 55.9%, a pigment to binder weight ratio of 30/100 and a viscosity of 52 second measured at 25C using a No.2 Fisher Cup.

Each of the above Coating Compositions A and B were tested for Hiding Power using TM-0352I Hiding of Automotive Basecoats (DuPont Test Method). Each of the compositions provided complete hiding at the same film thickness. Coating Composition A (the invention) made with iron oxide coated aluminum flake pigments had a pigment to binder ratio of 25/100 and used less of the expensive pigments of diketopyrrolopyrrol red pigment, quinacridone red pigment quinacridone pigment and benzirnidazolone orange pigment than did Coating Composition B which was formulated without the aluminum flake pigment and had a pigment to binder ratio of 30/100.

To form a sprayable composition, each of the above Coating Compositions A and B were adjusted to a spray viscosity of 20 seconds measured at 25C using a No. Fisher Cup by the addition of solvent. Less solvent was required for Coating Composition A to adjust to the spray viscosity and Coating Composition A (the invention) has a lower volatile organic content than Coating Composition B.

Each of the Coating Compositions A and B was sprayed onto separate steel panels that had been electrocoated with a cathodic primer of an epoxy amine resin crosslinked with an isocyanate. Each coating composition was sprayed to a film thickness of 0.8-1.2 mils (20.32-30.48 microns) and flash dried at 83° C. for 5 minutes and then a clear coat of 2 mils (50.8 microns) was spray applied and each panel was baked for 30 minutes at 130° C..

Each of the panels was measured for chip resistance using a standard gravelometer test in which stones are thrown against a coated panel and the panel is visually rated for chip resistance. The tests showed that Composition A that contained the colored aluminum flake had a 1 unit chip improvement over Composition B.

When examined visually under various lighting conditions such as indoor fluorescent light, strong spotlighting or outdoors in sunlight, the colored flake is not visible to the naked eye and the panel of Composition A containing the colored flake cannot be distinguished from the panel of Composition B which does not contain flake.

What is claimed is:

1. A coating composition comprising:
(a) a liquid carrier medium:
(b) pigment;
(c) a film forming binder of a polymer having reactive groups and a crosslinking agent which on curing of the coating composition will react with the reactive groups of the polymer to form a film and
(d) 0.1-3.0% by weight, based on the weight of the binder, of colored aluminum flake to provide the coating composition when applied to a substrate and cured with improved chip resistance and improved hiding power.

2. The coating composition of claim 1 in which the colored aluminum flake has a particle size of 1 to 50 microns and has a CIE LCH Hue angle value between 0 and 90 degrees.

3. The coating composition of claim 2 in which the colored aluminum flake is aluminum flake coated with iron oxide.

4. The coating composition of claim 3 in which the pigment is selected from the group of organic red pigments, organic orange pigments, organic yellow pigments and any mixtures thereof.

5. The coating composition of claim 4 wherein the film forming polymer is an acrylic polymer having reactive carboxyl groups or hydroxyl groups or mixtures thereof or a polyester having carboxyl groups or hydroxyl groups or mixtures thereof or the film forming polymer is a mixture of the acrylic polymer and the polyester.

6. The coating composition of claim 5 wherein the crosslinking agent is an alkylated melamine formaldehyde crosslinking agent, a polyisocyanate or a blocked polyisocyanate.

7. The coating composition of claim 5 wherein the acrylic polymer comprises the polymerization product of an alkyl (meth)acrylate having 1-12 carbon atoms in the alkyl group, hydroxy alkyl (meth) acrylate having 1-14 carbon atoms in the alkyl group and an ethylenically unsaturated carboxylic acid and optionally a polyester comprising the esterification product of an organic polycarboxylic acid and a polyol and the crosslinking agent comprises an alkylated melamine crosslinking agent.

8. The coating composition of claim 1 in which the colored aluminum flake is aluminum flake coated with iron oxide, has a particle size of 1 to 50 microns, and has a mass tone color position of CIE LCH Hue angle between 0 and 90 degrees; the pigment is selected from the group of organic red pigments, organic orange pigments, organic yellow pigments and any mixtures thereof; the acrylic polymer comprises the polymerization product of an alkyl (meth)acrylate having 1-12 carbon atoms in the alkyl group, hydroxy alkyl (meth) acrylate having 1-4 carbon atoms in the alkyl group and an ethylenically unsaturated carboxylic acid and optionally contains a polyester comprising the esterification product of an organic polycarboxylic acid and a polyol and the crosslinking agent comprises an alkylated melamine crosslinking agent.

9. A substrate coated with a dried and cured layer of the composition of claim 1.

10. The substrate of claim 9 having a layer of a dried and cured clear coating composition in superimposed adherence to the dried and cured layer.
